(19) United States
(12) Patent Application Publication
(10) Pub. No.: US 2006/0072269 A1
(43) Pub. Date: Apr. 6, 2006

(54) Amperage apparatus for displaying ralative amperage load

(76) Inventor: Peter Ethan Staples, Los Angeles, CA (US)

Correspondence Address: SCHOX PLC, 209 N. MAIN STREET #200, ANN ARBOR, MI, 48104, US

(21) Appl. No.: 10/957,174

(22) Filed: Sep. 30, 2004

(51) Int. Cl. H02H 3/08

(52) U.S. Cl. 361/93.1

(57) ABSTRACT

In a first embodiment, the invention is an amperage apparatus 10 for displaying relative amperage load. The amperage apparatus 10 includes a sensor 12 adapted to measure an amperage value, a processor 14 coupled to the sensor 12 and adapted to allow selection of an amperage rating, and a display 16 coupled to the processor 14 and adapted to display information based on the measured amperage value and the selected amperage rating. The amperage apparatus 10 may be used as a stand-alone device or may be incorporated into a power supply system, such as a power strip, a surge protector, or an uninterruptible power supply (UPS).

### BRIEF DESCRIPTION OF THE FIGURES

FIGS. 1 and 2 are schematic representations of the amperage apparatus of the first and second embodiments, respectively.

FIGS. 3, 4, and 5 are schematic representations of the power supply systems of the third, fourth, and fifth embodiments, respectively.

FIG. 6 is a flowchart representation of the method of the sixth embodiment.

FIGS. 7 and 8 are flowchart and schematic representations, respectively, of the method of the seventh embodiment.

### DESCRIPTION OF THE PREFERRED EMBODIMENTS

The following description of the preferred embodiments of the invention is not intended to limit the invention to these preferred embodiments, but rather to enable any person skilled in the art of power supply systems to make and use this invention.

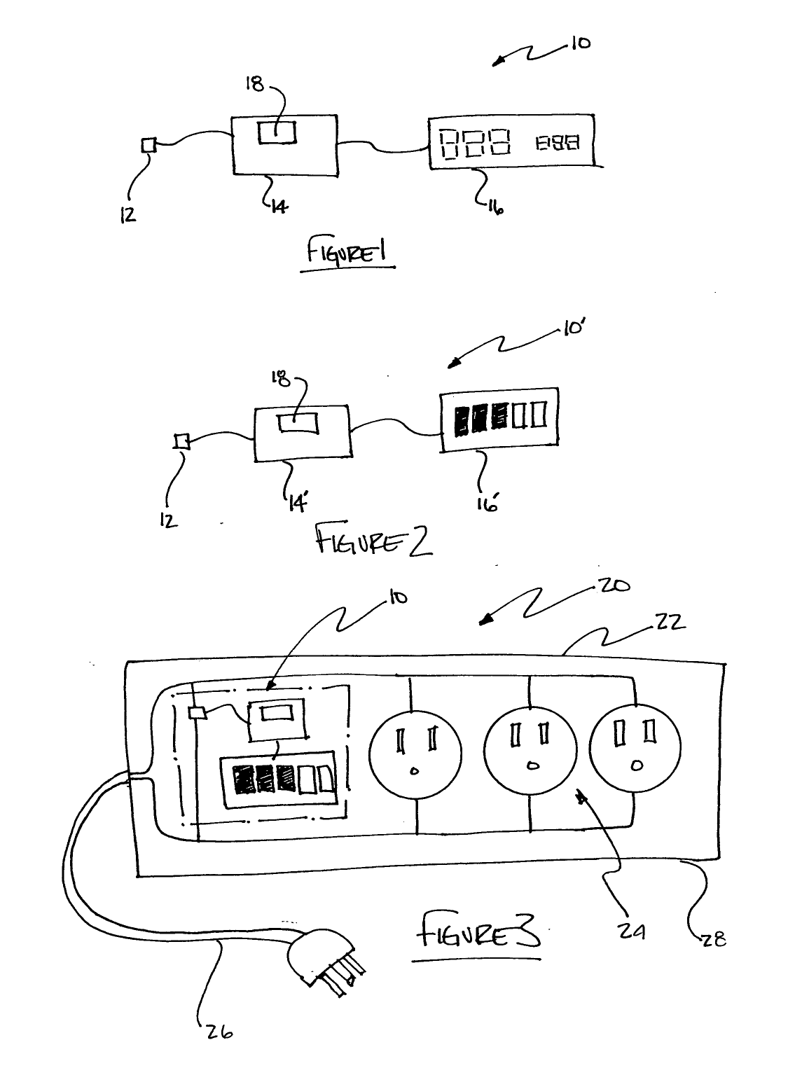

As shown in FIG. 1, the first embodiment of the invention is an amperage apparatus 10 for displaying relative amperage load. The amperage apparatus 10 includes a sensor 12 adapted to measure an amperage value, a processor 14 coupled to the sensor 12 and adapted to allow selection of an amperage rating, and a display 16 coupled to the processor 14 and adapted to display information based on the measured amperage value and the selected amperage rating. The amperage apparatus 10 may be used as a stand-alone device or may be incorporated into a power supply system, such as a power strip, a surge protector, or an uninterruptible power supply (UPS). The amperage apparatus 10 may alternatively be used in any suitable environment or incorporated into any suitable device or system.

The sensor 12 of the first embodiment functions to measure the flow rate of electrical current. Preferably, the sensor 12 includes a linear Hall integrated circuit. Alternatively, the sensor 12 may includes any suitable device able to sense and measure electrical current. The sensor 12 preferably measures the electrical current as an amperage value, but may alternatively measure the electrical current in other suitable units. The sensor 12 preferably senses the electrical current once per second, but may alternatively sense the electrical current at any suitable rate.

The processor 14 of the first embodiment, which is coupled to the sensor 12, functions to allow selection of an amperage rating. In one variation, the processor 14 is adapted to allow selection of an amperage rating amongst several predetermined amperage ratings. For example, the processor 14 may be adapted to allow selection of a first amperage rating appropriate for an old home wiring system (approximately 15 amps), a second amperage rating appropriate for a modern home wiring system (approximately 20 amps), or a third amperage rating appropriate for a workshop wiring system (approximately 30 amps). In another variation, the processor 14 is adapted to allow selection of an amperage rating along a continuous range. For example, the processor 14 may be adapted to allow selection of any amperage rating between 10 amps and 40 amps. In alternative variations, the processor 14 is adapted in any suitable manner to allow selection of an amperage rating.

To allow selection of the amperage rating, the processor 14 of the first embodiment preferably includes a selector 18. The selector 18 may be software-based or hardware-based. In the software-based variation, the selector 18 may include a read only memory (ROM) or any other suitable memory device, which can be programmed to allow selection of the amperage rating. In the hardware-based variation, the selector 18 may include a switch (e.g., a slide switch, a rotary switch, or a DIP switch) or any other suitable device, which can be actuated to allow selection of the amperage rating. In a further variation, the selector 18 may include two or more amperage ratings hardwired into a printed circuit board, which can be alternatively connected to allow selection of the amperage rating. In alternative variations, the selector 18 may include any suitable software or device to allow selection of the amperage rating.

The display 16 of the first embodiment, which is coupled to the processor 14, functions to display information based on the measured amperage value and the selected amperage rating. In the first embodiment, the information simply includes the measured amperage value and the selected amperage rating. In other words, the display 16 preferably displays both the measured amperage value and the selected amperage rating, either sequentially or simultaneously. In alternative embodiments, such as the second embodiment, the information may include other calculations based on the measured amperage value and the selected amperage rating. The display 16 preferably includes light-emitting diodes (LEDs), organic light-emitting diodes (OLEDs), liquid crystal displays (LCDs), or any other suitable device to display the information.

In a variation of the first embodiment, the processor 14 and display 16 may be adapted to visually or audibly communicate a relatively high measured amperage value. The processor 14 may be adapted to determine such a situation by calculating whether the measured amperage value is within a predetermined range (calculated either as a percentage value or as an absolute value) of the selected amperage rating. The display 16 may be adapted to communicate the situation by either displaying additional information or by displaying the original information in a different color (e.g., red) or in a different manner (e.g., blinking). The processor 14 and the display 16 may, however, be alternatively adapted in any suitable manner to determine and visually or audibly communicate a situation including a relatively high measured amperage value. In an additional variation of the first embodiment, the processor 14 may be further adapted to halt an electrical current if the measured amperage value exceeds the selected amperage rating. To halt the electrical current, the processor 14 may include a fuse, a circuit breaker, or any other suitable device.

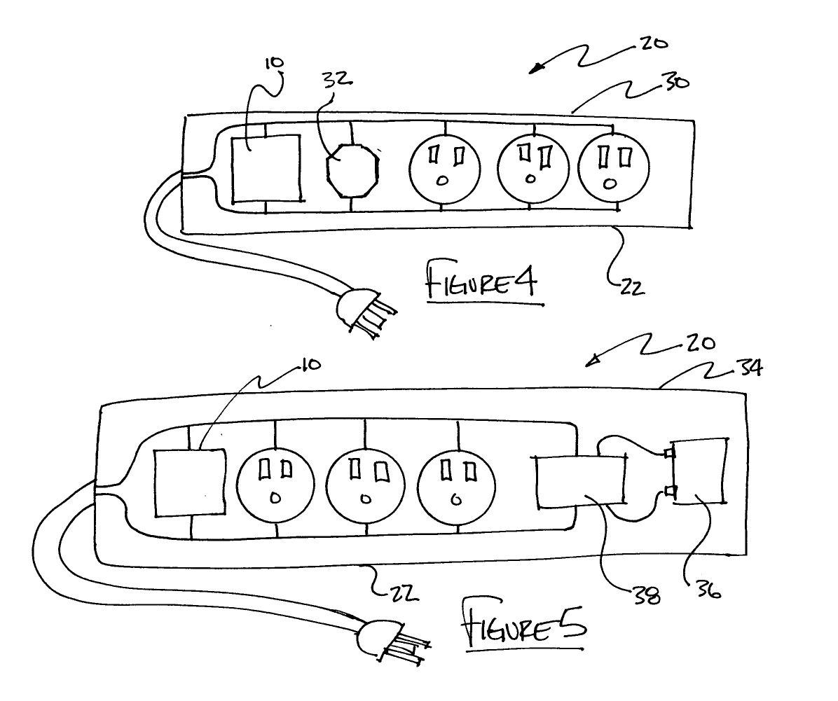

As shown in FIG. 2, the second embodiment of the invention is also an amperage apparatus 10′ for displaying relative amperage load. Like the amperage apparatus 10 of the first embodiment, the amperage apparatus 10′ of the second embodiment includes a sensor 12 adapted to measure an amperage value, a processor 14′ coupled to the sensor 12 and adapted to allow selection of an amperage rating, and a display 16′ coupled to the processor 14′ and adapted to display information based on the measured amperage value and the selected amperage rating. The processor 14′ and the display 16′ of the second embodiment are, however, further adapted.

The processor 14′ of the second embodiment is further adapted to determine a relative amperage load based on the measured amperage value and the selected amperage rating. Preferably, the relative amperage load is calculated by dividing the measured amperage value by the selected amperage rating. Alternatively, the relative amperage load may be calculated in any suitable manner. The display 16′ of the second embodiment is further adapted to display the relative amperage load. Thus, in the second embodiment, the information includes the relative amperage load. In a first variation (not shown), the display 16′ is preferably adapted to numerically display the relative amperage load as either a ratio or a percentage. In a second variation (shown in FIG. 2), the display 16′ is preferably adapted to graphically represent the relative amperage load in either a linear manner (e.g., multiple dots or bars) or in a rotary manner (e.g., a pie or a meter). The display 16′ may, however, be alternatively adapted to numerically or graphically represent the relative amperage load in any suitable manner.

As shown in FIG. 3, the third embodiment of the invention is a power supply system 20 in the form of a power strip 22, including a set of sockets 24, an electrical cord 26, a housing 28, and the amperage apparatus 10 of either the first or second embodiment. The set of sockets 24 function to provide additional outlets for a user. The sockets 24 are preferably conventional with a three-prong arrangement, but may alternatively be any suitable electrical socket with any suitable arrangement. The electrical cord 26 functions to connect the set of sockets 24 with a standard wall outlet. The electrical cord 26 is preferably made with conventional materials and in a conventional manner, but may alternatively be made with any suitable material and in any suitable manner. The housing 28 functions to enclose the set of sockets 24 and the amperage apparatus 10. The housing 28 includes socket openings that allow access to the sockets 24 and a display opening that allows a visual inspection of the display 16. The housing 28 is preferably made with conventional materials and in a conventional manner, but may alternatively be made with any suitable material and in any suitable manner.

The amperage apparatus 10 of the third embodiment functions to display the relative amperage load drawn from the standard wall outlet through the set of sockets 24. By using the power strip 22, a user will be able to make informed decisions about the placement of electrical appliances in their environment to reduce the risk of electrical overload. The amperage apparatus 10 is preferably adapted to measure the total flow rate of the electrical current through the set of sockets 24, but may alternatively be adapted to measure the individual flow rate of electrical current through an individual socket. The amperage apparatus 10 may alternatively be further adapted to selectively measure either the total electrical current or an individual current through the set of sockets 24.

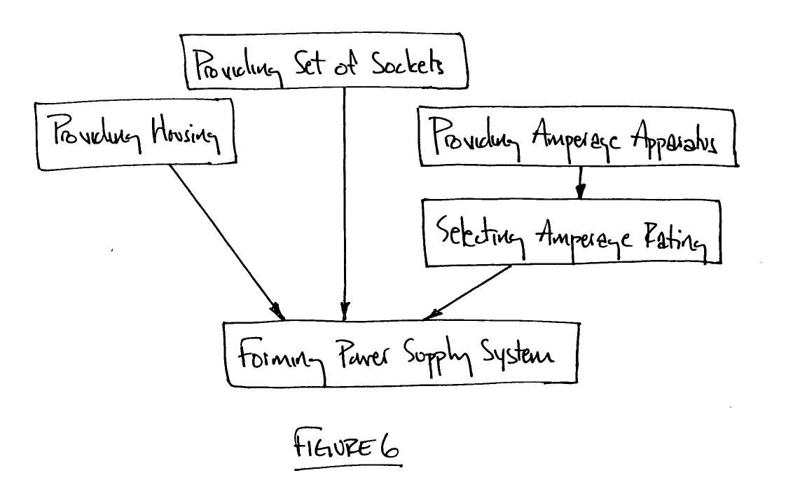

As shown in FIG. 4, the fourth embodiment of the invention is a power supply system 20 in the form of a surge protection system 30, including the power strip 22 of the third embodiment and a surge protector 32. The surge protector 32 functions to divert an electrical current to a grounding wire during a power surge. A power surge, or transient voltage, is an increase in voltage significantly above the designated level in a flow of electricity. The surge protector 32 preferably includes a metal oxide varistor (MOV), but may alternatively include a gas discharge arrestor or any other suitable device.

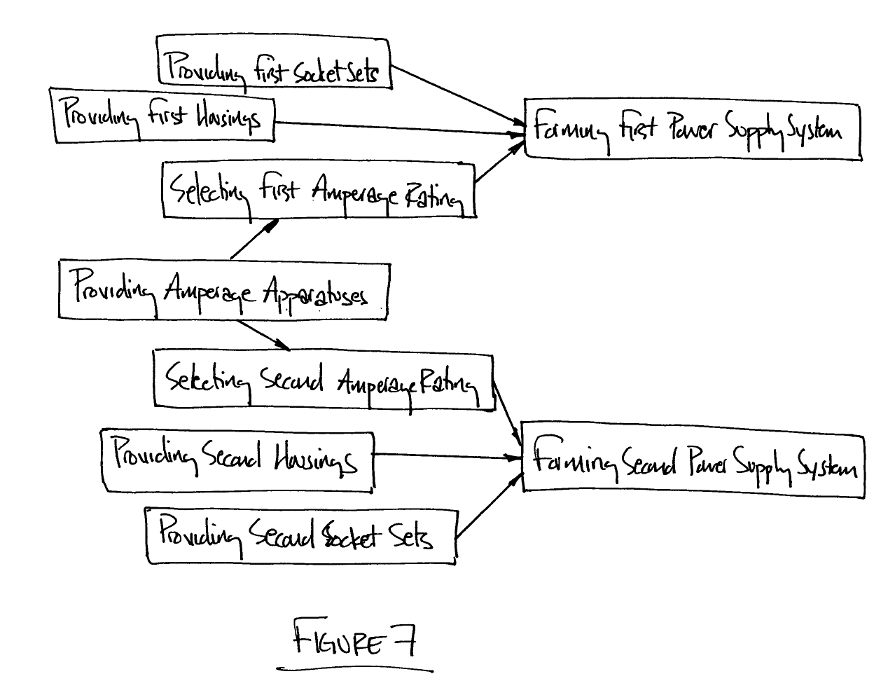

As shown in FIG. 5, the fifth embodiment of the invention is a power supply system 20 in the form of an uninterruptible power source 34, including the power strip 22 of the third embodiment, a battery 36, and a power inverter 38. The uninterruptible power source 34 functions to provide an electrical current during a power outage. The battery 36 and power inverter 38 function to convert AC power from the standard wall outlet into DC power, to store the DC power, and to convert the DC power back into AC power during a power outage. In alternative variations, the uninterruptible power source 34 may include other suitable devices to assist in the conversion, storage, or re-conversion process.

As shown in FIG. 6, the sixth embodiment of the invention is a method for forming the power supply system 20. The method includes providing the housing 28, providing the set of sockets 24, providing the amperage apparatus 10, and combining the housing 28, the set of sockets 24, and the amperage apparatus 10 to form the power supply system 20. The method also includes selecting the amperage rating for the processor 14 of the amperage apparatus 10 before forming the power supply system 20. By selecting the amperage rating before forming the power supply system 20, the power supply system 20 may be operated by a user without any input from the user. In other words, the power supply system 20 would not require any configuration by the user. The step of selecting the amperage rating may include programming the amperage rating, hardwiring the amperage rating, or any other suitable step.

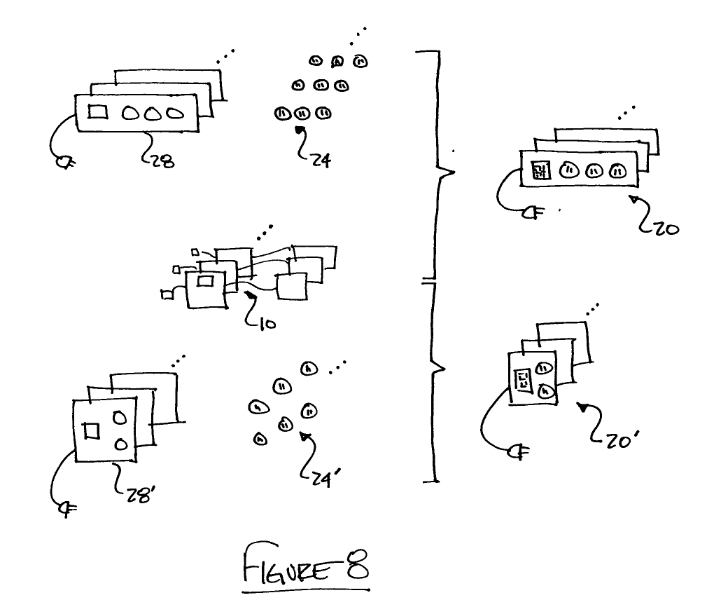

As shown in FIGS. 7 and 8, the seventh embodiment of the invention is a method of forming two power supply systems 20 and 20′. The method includes providing a first series of substantially similar housings 28, a first series of substantially similar socket sets 24, a second series of substantially similar housings 28′, a second series of substantially similar socket sets 24′, and a series of substantially similar amperage apparatuses 10. The method also includes selecting a first amperage rating for a first amperage apparatus 10 of the series of amperage apparatuses 10 and combining a housing 28 from the first series of housings 28 and a socket set 24 from the first series of socket sets 24 with the first amperage apparatus 10 to form a first power supply system 20 with a first amperage rating. Similarly, the method also includes selecting a second amperage rating for a second amperage apparatus 10 of the series of amperage apparatuses 10 and combining a housing 28′ from the second series of housings 28′ and a socket set 24′ from the second series of socket sets 24′ with the second amperage apparatus 10 to form a second power supply system 20′ with a second amperage rating. Preferably, the second amperage rating differs from the first amperage rating. In this manner, one of the amperage apparatuses 10 may be configured for a first power supply system 20, while another of the amperage apparatuses 10 may be configured for a second power supply system 20′. Thus, the singular design of the amperage apparatus 10 may reduce the part count, the assembly complexity, and overall costs of supplying two power supply systems 20 and 20′ with different amperage ratings.

Like the method of the sixth embodiment, the steps of selecting amperage ratings preferably are performed before forming the power supply systems 20 and 20′. Specifically, the step of selecting a first amperage rating is performed before forming a first power supply system 20 and the step of selecting a second amperage rating is performed before forming a second power supply system 20′. By selecting the amperage ratings before the formation of the power supply systems 20 and 20′, the power supply systems 20 and 20′ may be operated by a user without any input from the user. In other words, the power supply systems 20 and 20′ would not require any configuration by the user. The steps of selecting the amperage ratings may include programming the amperage ratings, hardwiring the amperage ratings, or any other suitable step.

The method of the seventh embodiment may include several variations. In a first variation, the form factor of the housings 28 from the first series of housings 28 differs from the form factor of the housings 28′ from the second series of housings 28′. The form factor of the housing 28 from the first series of housings 28 may be elongated like a conventional surge protector. The form factor of the housings 28′ from the second series of housings 28′, on the other hand, may be cubical like a conventional uninterruptible power supply. In a second variation, the number of sockets 24 in the socket sets 24 from the first series differs from the number of sockets 24 in the socket sets 24 from the second series. The number of sockets 24 from the first series may be four, while the number of sockets 24 from the second series may be six. In a third variation, the first power supply system 20 may further include a surge protector 32, while the second power supply system 20′ may further include an uninterruptible power supply. In alternative variations, the first power supply system 20 may differ in other suitable ways from the second power supply system 20′.

As a person skilled in the art of power supply systems will recognize from the previous detailed description and from the figures and claims, modifications and changes can be made to the preferred embodiments of the invention without departing from the scope of this invention defined in the following claims.

I claim:

1. An amperage apparatus for displaying relative amperage load, comprising:
a sensor adapted to measure an amperage value;
a processor coupled to the sensor and adapted to allow selection of an amperage rating; and
a display coupled to the processor and adapted to display information based on the measured amperage value and the selected amperage rating.

2. The amperage apparatus of claim 1 wherein the display is adapted to display the measured amperage value and the selected amperage rating.

3. The amperage apparatus of claim 1 wherein the processor is further adapted to determine a relative amperage load based on the measured amperage value and the selected amperage rating, and wherein the display is adapted to display the relative amperage load.

4. The amperage apparatus of claim 3 wherein the display is adapted to graphically represent the relative amperage load.

5. The amperage apparatus of claim 3 wherein processor is further adapted to allow software-based selection of the amperage rating.

6. The amperage apparatus of claim 3 wherein processor is further adapted to allow hardware-based selection of the first amperage rating and the second amperage rating.

7. The amperage apparatus of claim 6 wherein the processor includes a switch adapted to allow the hardware-based selection of the first amperage rating and the second amperage rating.

8. The amperage apparatus of claim 3 wherein the processor is further adapted to halt an electrical current if the measured amperage value exceeds the selected amperage rating.

9. A power supply system, comprising: a housing; a set of sockets; and the amperage apparatus of claim 1.

10. The power supply system of claim 9 further comprising a surge protector adapted to divert an electrical current to a grounding wire.

11. The power supply system of claim 9 further comprising an uninterruptible power source adapted to provide an electrical current during an outage.

12. A method of forming a power supply system comprising the following steps:
a. providing a housing;
b. providing a set of sockets;
c. providing an amperage apparatus including a sensor adapted to measure an amperage value, a processor coupled to the sensor and adapted to allow selection of an amperage rating, and a display coupled to the processor and adapted to display information based on the measured amperage value and the selected amperage rating;
d. combining the housing, the set of sockets, and the amperage apparatus to form a power supply system; and
e. before the formation of the power supply system, selecting the amperage rating for the processor of the amperage apparatus.

13. The method of claim 12 wherein step (e) includes programming the amperage rating for the processor of the amperage apparatus.

14. The method of claim 12 wherein step (e) includes hardwiring the amperage rating for the processor of the amperage apparatus.

15. A method of forming two power supply systems comprising the following steps:
a. providing a first series of substantially similar housings, a first series of substantially similar socket sets, a second series of substantially similar housings, and a second series of substantially similar socket sets;
b. providing a series of substantially similar amperage apparatuses, each amperage apparatus including a sensor adapted to measure an amperage value, a processor coupled to the sensor and adapted to allow selection of an amperage rating, and a display coupled to the processor and adapted to display information based on the measured amperage value and the selected amperage rating;
c. selecting a first amperage rating for a first amperage apparatus of the series of amperage apparatuses;
d. combining a housing from the first series of housings and a socket set from the first series of socket sets with the first amperage apparatus to form a first power supply system with a first amperage rating;
e. selecting a second amperage rating, which differs from the first amperage rating, for a second amperage apparatus of the series of amperage apparatuses; and
f. combining a housing from the second series of housings and a socket set from the second series of socket sets with the second amperage apparatus to form a second power supply system with a second amperage rating.

16. The method of claim 15 wherein step (c) is performed before step (d), and wherein step (e) is performed before step (f).

17. The method of claim 16 wherein the form factor of the housings from the first series of housings differs from the form factor of the housings from the second series of housings.

18. The method of claim 17 wherein the number of sockets in the socket sets from the first series of socket sets differs from the number of sockets in the socket sets from the second series of socket sets.

19. The method of claim 15 wherein step (c) includes programming the first amperage rating; and wherein step (e) includes programming the second amperage rating.

20. The method of claim 15 wherein step (c) includes hardwiring the first amperage rating; and wherein step (e) includes hardwiring the second amperage rating.
